(19) United States
(12) Patent Application Publication
(10) Pub. No.: US 2014/0279731 A1
(43) Pub. Date: Sep. 18, 2014

(54) System and Method for Automated Text Coverage of a Live Event Using Structured and Unstructured Data Sources

(71) Applicant: Ivan Bezdomny Inc., Long Island City, NY (US)

(72) Inventor: Nikolai V. Yakovenko, Long Island City, NY (US)

(21) Appl. No.: 13/802,691

(22) Filed: Mar. 13, 2013

(51) Int. Cl. G06F 15/18; G06N 99/00

(52) U.S. Cl. CPC G06F 15/18; G06N 99/005
USPC 706/12

(57) ABSTRACT

A system for providing text coverage of a live event, comprising one or more computing devices configured to receive information from one or more structured data sources and from one or more unstructured data sources, and to output information derived therefrom in a periodically updated timeline; a game data processing system comprising a system for deriving data and a story generation system; a social media processing system; and a data source mixing system. A detailed specific example of an embodiment is disclosed in which the live event is a basketball game.

### BRIEF DESCRIPTION OF THE DRAWINGS

FIG. 1 illustrates a game data processing system in an embodiment of the present invention.

FIG. 2 illustrates in more detail the derivation of data by the game data processing system of FIG. 1.

FIG. 3 illustrates a story generation system in an embodiment of the present invention.

FIG. 4 illustrates a social media understanding and timeline system in an embodiment of the present invention.

FIG. 5 illustrates a data source mixing system in an embodiment of the present invention.

FIG. 6 illustrates a versioning and personalization system in an embodiment of the present invention.

FIG. 7 is a screen-shot of a web-based system used in machine learning in an embodiment of the present invention.

### DETAILED DESCRIPTION OF AN EMBODIMENT

An embodiment of a system of the present invention tailored to the example of the live event of a basketball game is described in detail here, but it will be appreciated that the invention can be tailored readily to a variety of live events. The described embodiment (“the system”) organizes available basketball game information and processes it into live coverage of the game. In this embodiment, the input includes structured data (i.e., well-organized and in a known format) in the form of play-by-play data for the game in progress as well as unstructured data (i.e., consisting of free text that cannot be organized easily into structured information) in the form of social media updates. These inputs are processed to produce an ordered set of text updates about the live game that are written iteratively in real time, so as to narrate the game from start to present. The updates may also be or include video and photos. The system may output multiple timelines for the same game simultaneously, each generated for different audiences, different devices that display the updates, and/or based on various other output constraints. Salient aspects of the system are a game data processing system (FIG. 1) comprising a system for deriving data (FIG. 2) and a story generation system (FIG. 3), a social media understanding and timeline system (FIG. 4), and a data source mixing system (FIG. 5); the system may also comprise a versioning and personalization system (FIG. 6).

As outlined in FIG. 1, the system includes a game data processing system 100 that turns ongoing play-by-play data for the live game into detailed current data about teams, individual players, groups of players, and the order of the scoring. As outlined in FIG. 2, a system for deriving data 200 produces all of the data necessary to check whether individual story types should be considered for writing. As outlined in FIG. 3, the story generation system 300 takes current game data from the game data processing system and applies numerous (e.g., hundreds of) possible story types to determine which stories can be written about the game in its current state; it then writes those stories using case-based reasoning, computes a rank value for each based on relevance to the current game state, and finally chooses whether any of the current generated stories should be added to any of the timelines being generated for the game. As outlined in FIG. 4, the social media understanding and timeline system 400 collects recent social media updates, parses each for meaning and relevance (including determining likely topic, possible relevance to the game, and mention of entities such as players, teams, and coaches), produces a list of likely relevant social media updates tagged by entity and topic, and finally chooses which, if any, of these social media updates should be added to any timelines for the game based on the relevance and content of the update as well as information already existing in the timeline (including updates from generated stories). FIG. 5 outlines how the data source mixing system 500 cohesively blends information from the structured and unstructured data sources to produce live game timelines. As seen in FIG. 6, a versioning and personalization system 600 can be employed to customize for various output requirements, including by adjusting requirements on the generated timelines and by modifying specific inputs.

Referring to FIGS. 1 and 2, the play-by-play data (new plays) 101/201 is a set of plays in the game, ordered by the time in which they occurred, consisting of collections of relevant known event types, i.e., individual Play objects 102. Play-by-play data contains: the game score, the game time, the event type (from a prior known list), the event player, other secondary players involved, and the result of the play (whether the shot went in or not). The play-by-play can also include descriptive clauses, such as the type of shot attempted (dunk or jump shot), again from an enumerated, prior-known list of possible clauses. An example of a play from play-by-play data could be: {time: Q1-9:52, team: Knicks, play type: shot, player: Amare Stoudemire, player assist: Landry Fields, event result: made, event type: two point shot, score: 8-6}

As the game data processing system 200 gets a series of play-by-play data (new plays) 101/201, that data is used to update internal data about players, teams, lists of players, and the game status. The current state for various types of data about each player is kept as player data 103/203, and is updated with the latest play-by-play data. This can start with the player's “counting stats,” which are the traditional box score statistics like points, rebounds, fouls, and minutes played. Counting stats may also include the number of dunks, number of assisted shots, and any other data that can be computed simply from counting the plays of a type that a player has been involved in. From these counting stats, player value stats are kept, according to known formulas published by well-known basketball statisticians Dean Oliver, John Hollinger, and others. These player value stats include offensive rating, defensive rating, and usage rate, and make it easy to answer questions like “Who is the best player in this game?” and “Is the player having a good game, based on league norms for his position?”

The system can also track time-sensitive statistics, summarized by a “player temperature” statistic, for example starting each player with a neutral 72° score, and changing that metric up and down with active plays or periods of inactivity. The system can also track a player's stats within the past few minutes, to help answer questions like “Which player is hot right now?” and “Which player contributed most to a team's recent success,” as well as backward-looking questions like “Did the player start the game hot or cold?” The system can also track mathematical answers to specific questions not easily derived from the stats described above.

For questions like “Is the player hitting open shots?” or “Is he shooting poorly from long distance?”, a human knowledgeable in the sport selects positive and negative examples for each question from real game data where players satisfied those criteria, and based thereon the system employs machine learning to devise an algorithm that predicts similar cases in the future. Specifically, all of the other stats above for the individual cases where a human labeled a player as having met the qualitative condition above, or not, are input, and then standard feature selection machine learning methods are used to find the most relevant several stats, from which is derived a linear model for predicting whether a future player meets the given condition or not. As an example, it has been found that for “hitting open shots,” the relevant stats are: game time (% of game played so far), number of assisted jump shots made, field goal %, and “inside” field goal % (limited to short-distance shots like dunks and layups). On the other hand, for “shooting badly from long distance,” the relevant stats are: field goal %, number of field goals made, and number of assisted field goals made. The formulas derived from machine learning, while not very long or sophisticated, are too complex for a human to derive from first principles, but given real game cases and the right set of counting stats to consider, robust conditions can be established for knowing how a player's stats answer such qualitative questions.

The system also pre-computes short player performance phrases 206 useful in describing a player's performance. By looking at a player's offensive rating, overall rating, and contribution percentage (an estimate of how many of his team's plays a player was a part of), the system places players into buckets of performance type, which are assigned a two- or three-word description ranging from “did not play,” “contributed little,” and “contributed,” to “played great,” “carried his team,” and “hurt his team,” depending on both the quality and quantity of performance. This two- or three-word player description is useful in building sentences for generated stories, succinctly describing a player's performance. For example, the system may write “LeBron James is injured. He carried his team when he played.”

For cases where a player's statistics might be quoted to explain his performance, the system can also describe a player's performance in the two or three most relevant statistics. Deriving that description can start with considering the possibly relevant statistics for a type of performance description; for example, relevant to describing offensive performance would be: points scored, three-pointers made, assists, offensive rebounds, and turnovers. League norms 202 can then be used to determine which two or three of the stats are the most relevant to describing a player's performance so far.

Rather than guess which is more significant, 20 points or 10 assists, both numbers can be expressed in terms of statistical norms from past records for the given basketball league. (Norms should be computed on a league-by-league basis and the player summary phrases should reflect differences between them; for example, men's college games have much lower scoring (but lower rebounding) than NBA games, players make fewer three point shots and play a shorter game). For example, the NBA norm for a starting player is 15.0 points, with a standard deviation of 7.2 points; thus a player scoring 20 points is +0.7 standard deviations above the norm. For assists, the NBA starting player norm is 4.2 assists with a standard deviation of 2.2 assists, so a player recording 10 assists is +2.6 standard deviations above the norm. Consequently, the system preferably writes about the player's 10 assists before mentioning his 20 points.

In steps 206 and 207, the system computes phrases summarizing a player's performance in various aspects of the game, which can be used as needed by the story generation system 300. Phrases are computed to summarize: offensive performance, defensive performance, overall performance, as well as performance in the past five minutes of the game, and for past periods like “early in the game.”

The system keeps team data 104/204 in the form of “box scores” or stats similar to those kept for the players, and preferably may also keep such data for groups of players to be considered together. These groups include all starters, all bench players, all players of the same position, and various five-man lineups that play together. This allows the system to determine which lineup or set of players has played significantly above or below expectations, or is the key to a team's success. As with individual players, the system can compare a set of players' stats to league-specific statistical norms for similar lineups. Thus the system can, for example, determine that a team's bench is playing very well compared to league norms, and can generate a phrase describing that bench's performance in two or three key stats.

Game status data 105/205 and game status-derived data 208 track the score and game time, both currently in the game and as a time series of the game so far. From the game score and time left, at each point the system estimates a winning probability for each team based on historical league results for similar scores and time left. An “excitement index,” which measures how much the current game winning probability can be changed by an immediately made basket, is also calculated. (For example, if the game is tied with one second left, the excitement index is 100%; if there are five minutes left and one team leads by 20 points, the excitement index is less than 1%). The system uses time series of scores, game times, and estimated winning probabilities associated therewith to compute answers to questions such as: “When was the first and largest lead for each team?”, “Is there a scoring run taking place (continuous one-sided scoring by one team)?”, “How close has the game been to now (what % of the game has been within three points)?”, “Is there a comeback underway (one team had a large expected winning percentage at an earlier point, but not any longer)?”, “Is the game close, or is it unlikely that one team can win given the lead and time left?” The system computes answers to these questions based on the game statistics so far, so story generation need only check the answers, rather than wade through the score and game time series.

Turning next to FIG. 3 (see also steps 106-110 of FIG. 1), the story generation system 300 employs a class of story generators 302-305, which are called at step 106 to generate stories relating to the game. Specific instantiations of the class (“StoryGenerator class”) are devised to write specific types of stories, utilizing data computed previously for players, teams, and the game status. If the conditions for an individual story generator are met, it creates a GameStory object containing: story text, story score (how important is the story, relative to other stories), story type (enumerated from a known list of stories that could be output), and story entity (player, team, or coach whom the story is primarily about). Numerous story generators are preferably provided, each checking for conditions for one or more story types. Each of the story generators is called when game data is updated. These self-contained objects check the conditions for their stories to trigger, and if the conditions are met, they generate stories and pass them to an aggregator.

For example, player story generators 107/302 can include: a TopOffensivePlayerStoryGenerator, which looks for players meeting conditions for good offensive performance, carrying the team's offense, or a triple-double or other rare statistical feats; a TopDefensivePlayerStoryGenerator, which looks for players meeting conditions for a good defensive performance, leading a team's defense, or a rare achievement within a single defensive category (rebounds, blocked shots, and steals); a GoodBothEndsPlayerStoryGenerator, which looks for players with both good offensive and good defensive performances; a BadOverallPlayerStoryGenerator, which looks for players who have not played well (e.g., starting by looking at overall performance ratings compared to league norms, then trying to identify the reason for a player's poor performance, such as poor shooting, bad ball handling, or a lack of contribution for a lot of minutes played); a PlayerFoulTroubleStoryGenerator, which looks for players who are in foul trouble, have received technical fouls, or have been ejected for either, and reports when a player is in foul trouble and advises how well he has played while in the game, so that fans can follow how his absence affects the game going forward; a TopBenchPlayerStoryGenerator, which looks for good performance from reserve players, preferably applying different standards of performance than with starters; a StarterPlayingLowMinutesGenerator, which uses league norms for low starter minute conditions to look for players who started but haven't played much, particularly if the player has little foul trouble and no reported injury; a MultiplePlayersBigMinutesStoryGenerator, which looks for cases where multiple players are playing long minutes, such as when the coach leaves whole lineups in the game (it also makes for more efficient writing to treat players together in this way rather than writing two or three of the same story); a PlayerHighMinutesStoryGenerator, which looks for players playing an unusually high number of minutes (at each point in the game, based on league norms—e.g., a starter playing the first quarter of the game without a break is not unusual, but playing the entire first half is rare) and generates a story phrased such as “Coach X is depending on player Y, leaving him in for 40 minutes”; an InjuredPlayerStoryGenerator, which (preferably utilizing social media data input, as described further below) writes stories about players that are out of the game and likely injured, and other stories about players who sustained an earlier injury but are back on the court; a HotColdPlayerStoryGenerator, which looks for hot players (90°+ in the player data) and writes different stories depending on what the player is doing well, as well as being hot; etc.

Various story generators may create numerous different story subtypes. For example, the HotColdPlayerStoryGenerator can be broken into dozens of different story subtypes based on whether the player is hot or cold and the type of performance focused on. If a player has created most of his team's points in the last five-minute stretch, the story generator would write a story to the effect of “player is energizing his team with [insert two or three top stats from computed offensive performance phrase].” If a player makes an assisted shot, and the pre-computed norm for “hitting open shots” is true, the generator would write “player has been hitting the open jumper all game, now with X points.” If the player started out this game cold (according to pre-computed norms) but is now hot, it would write, “after starting cold, player X is heating up with [insert two or three top stats from pre-computed offensive performance phrase].” Similarly, for cold players (e.g., below 70°), it would write one of a number of cold-player stories. If the player has just missed a shot, and has been shooting poorly all game (according to a pre-computed norm), it would write, “player X misses another shot, and his hurting team Y with his shooting.”

The TeamStoryGenerator 108/303 looks for cases where a team is shooting (all shots, three-point shots, free throw shooting) especially well or poorly with respect to league norms, and for example can write that a team is “leaving points at the line” if they are missing many free throws.

Team Disparities Story Generators 109/305 include a TeamDominanceStoryGenerator, which can generate a number of stories based on dominance in various aspects of the game such as shooting, rebounding, bench play, free throw shooting, and three-point shots; a GameFGDisparityStoryGenerator, which identifies disparities between teams and/or between the game and league norms, and may be tailored to write stories that depend on the time in the game (e.g., if many shots are being made early in the game, the generator may write that “everything is falling in early”) and may give statistics for the teams' shooting (as well as descriptions like “shooting well” or “shooting lights out”).

Game Status Story Generators 110/304 reflect the game status (time series of game scoring) and include a ClosenessExcitementStoryGenerator, BlowoutStoryGenerator, and CurrentComebackStoryGenerator to write stories if the game is close, a blowout, or a significant comeback by one of the teams is taking place; a TeamLeadsStoryGenerator and the LeadTrackerStoryGenerator to write if the team is taking its first lead, biggest lead, first lead for a long time, or when there are many lead changes; a GameBreakStoryGenerator to write stories for when games begin, when they end, or if the game is tied in regulation and heads for overtime; a BigPlayStoryGenerator that looks for made or missed shots late in the game, which by their result, have a significant effect on expected game winning percentage (e.g., that swing the game from “within reach” to “out of reach”) and can describe the play in detail; and a CurrentScoringRunStoryGenerator that identifies one-sided scoring by a team (e.g., scoring 10 points to its opponent's 0 or 2 points), by looking for scoring disparity over short periods of time, and also by shifts in expected winning percentage before and after the scoring run, and may describe the resulting change in odds (“back in the game,” or “pulling away”) and may state that a particular player or aspect of the game contributed disproportionately to the scoring run (e.g., “player X leads with all 10 points” or “they are playing stingy defense with 3 steals”).

In each case where the Story Generator triggers and a story is to be written, an individual story 310 is generated using case-based reasoning constructed from phrases that are filled in using the relevant Game Status Data 309 (taken from Game Status Derived Data 208), Team Data 308 (from the output of Team Data 204), Player Data 307 (from the output of Recent Player Data 207), and Performance Description Phrases 206. For example, in the example, “Ridiculous FG % for this game. Arkansas is shooting lights out at 75% (15-20) while Florida is shooting an abysmal 33% (5-15). Arkansas is winning 39-18, late 1st half.”, the phrases “ridiculous,” “lights out” and “abysmal” are pre-computed from the current team performance statistics, and are derived from comparison to league-level norms for team performance. In the example, “Arkansas bench is outplaying the Florida bench. They have more points 19-3 and more rebounds 5-0. Led by B J Young with 5 assists, 2 treys and 6 points.”, the system adds a clause about player B J Young's performance because he has the most “points produced” from the Arkansas bench, and a phrase was pre-computed to describe his offensive performance.

The system may utilize different versions of some texts, for different output formats. Twitter limits text to 140 characters, so output for Twitter would be abbreviated accordingly by shortening words, removing parts of speech, and also cutting out supporting clauses in the sentences produced. The system also may employ different words for the same story, to orient the writing toward one team or the other (e.g., when one team is winning, the other team is losing).

Each story is generated with a “story score,” which is a number that represents how important the story is relative to other stories being generated concurrently, similarly to the way Google scores a set of documents or colleges grade students on several parameters to rank them for priority in admissions. There is a baseline score for each story type, reflecting how interesting and timely that type of story tends to be. Comebacks and scoring runs lead to high story scores, since these stories are rare thus always interesting, and must be written about at the moment that they take place. On the other hand “good offensive performance” stories are not as timely or unique, and thus carry lower story scores.

If the story is based on a statistical norm cutoff, the story score is increased if the norm is actually above the minimal cutoff. For example, the minimal notable scoring run may be a 6 to 0 scoring run by one team, with a higher story score being assigned to a larger scoring run, e.g., 12 to 2. For parity between different story types, the system assigns a consistent story score bonus to norms above the minimum, which can be expressed in a common currency like points scored or produced. Thus a story about bench performance will look at those performances on the scale of points produced, similarly as a story about very good (or very bad) free throw shooting. The story score bonus is added when writing a story triggers an optional text clause; for example, “With a quick 11-5 run, Rockets cut the Heat lead to 3 points, 109-106 with 28 seconds left. They're right back in it! James Harden scored all 11 points.” Here, “They're right back in it!” and “James Harden scored all 11 points” are optional clauses, and thus lead to a higher story score than the standard scoring run story.

All stories are labeled by the type of the story, and though the set of story types may be large (e.g., over a hundred), it is known and finite. More complicated story types might be sub-typed; for example, the simple story “Jrue Holiday is having a good offensive game with 13 points (6-10 FG), 4 assists and a trey” has story type TopOffensivePlayer. On the other hand, a more complex story with clauses “Off of Jrue Holiday's dish, another bucket for Thaddeus Young. He's knocking down the open J all day for 76ers, now has 16 points” has story type with subtyping HotColdPlayer:Hot:OpenJ.

The system keeps track of story types, and in merging them at step 111/311 and collecting them at step 112, may nest them in a hierarchy in order to compare similar stories more easily in the timeline generation phase. Most stories are primarily about a team, player, or coach, and this information is stored as the story “entity.” For example, “P. J. Carlesimo is hoping to seize momentum, keeping Gerald Wallace (34 min) in the game. He's played well with 13 pts (3-5 FG), 5 assists and 7 boards.” is about the entity: player Gerald Wallace. On the other hand, “Nets take their biggest lead of the game with a Deron Williams free throw. Up 8 pts, 20-12 late Q1.” is about entity: team Nets. The system tracks story entities to monitor how much it is writing about each team, player, or coach. Monitoring the primary entity (as well as story types) can be used to allow the system to avoid writing the same or similar stories too often in a timeline, and also makes it possible to display useful information (e.g., pertinent player or team images) alongside the stories.

Using an iterative approach, the system generates several (perhaps many) simultaneous timelines about the game in progress, ultimately choosing zero, one, or two new stories at step 317 and push them to the user at step 117 by appending them to timeline(s) at step 318. At a high level, this is done by looking at the top generated stories at a given moment, and choosing stories to add to each timeline at step 116, provided the stories are sufficiently different from previous stories 113, and the output rate is not diverging greatly from the expected rate for that type of timeline. For each timeline to which output may be added, the system takes the current generated stories, and modifies story scores based on previous stories in that timeline. After decreasing the scores for recent stories that are similar to candidates for addition in step 114, the system considers the highest scoring re-scored story, and adds it if it meets the minimum cutoff (computed at step 115) for the timeline. This may be done using a “greedy algorithm,” adding stories to a timeline as soon as a story is found meeting the minimum cutoff for output without waiting to see if a story might develop into a higher-scoring story in the next few minutes. For example, the system will write about an 8-0 scoring run without waiting to see if the run increases to 12-0.

Story score adjustment is valuable in generating real-time game coverage timelines that cover all of the important game angles as they happen, stick closely to an expected overall per-game story output rate, and yet are pleasant to read and non-repetitive. As noted above, generated stories are scored so they can be sorted to give a good indication of which current stories are most important at a given moment; however, just adding the current “top story” to the iterative timelines is inadequate as it would result in the same story over and over, with minimal changes in details. For example, it could result in output like “LeBron is having a great game with 28 points,” followed minutes later by “LeBron is having a great game with 32 points.”; or in a defensive struggle, “Player X is cold,” followed by “Player Y is cold, and shooting poorly.” By generating a large number of different story types, a story can be written for every significant story angle that could occur in a game; and duplication can be avoided by employing an algorithm to understand which stories are the same (even if the details differ slightly), and which are similar (even if they are generated by different story generators).

When determining which story to write next for each timeline, at step 313 the system demotes the raw scores for all current stories 312, based on the previous timeline stories 314 written to that timeline, resulting in current stories with demoted scores 315. The system demotes very strongly if there was a recent story with the exact same Story Type and Entity. For example, from the example above, any story of type TopOffensivePlayer and entity LeBron would be considered a version of the same story, regardless of the story text. The system applies smaller but significant score demotions to stories that have the same Story Type or Entity (but not both) as recent stories in the timeline. For that same example, the system would demote all TopOffensivePlayer stories for that timeline, even though they are stories about different players. And the system demotes all stories about LeBron, so that stories about other entities have a better chance to make it to the diversified timeline.

By that same token, the system applies smaller demotions to stories that have had similar stories to them recently added to the timeline. The system maintains a simple map of “related story types” and applies half the demotion that would apply for stories that are exactly the same. For example, ScoringRun:PullingAway is a weak match for ScoringRun:QuickRun since both stories describe scoring runs by one team. In this case, the system knows they are similar stories because they share the same base story type. On the other hand, BadOverallPlayer and HotColdPlayer:Cold story types are also related. Even though they are not the same type of story, they will often convey the same information. Writing about one will make the system demote the other, especially if the stories are about the same entity.

As noted, the system demotes stories based on the Story Type and Entity of previous stories in the timeline under consideration. These include several demotion types: StoryType and Entity match (same exact story), StoryType match only, Entity match only and similar story (StoryType is related, but not the same). Each type of demotion has a maximum demotion, and a maximum time after which the demotion expires. For example, Entity match demotions apply up to 350.0 story score points, and up to 6 minutes of game time. The Story Type match demotions apply up to 250.0 points and up to 10 minutes. Exact match (Story Type & Entity match) demotions apply up to 70% of the story score or 600.0 points, whichever is larger, but these large demotions apply up to only 3 minutes of game time.

In all cases, the demotion is computed by looking up the latest story written on the timeline which matches the given criteria, and applying the demotion as a linear interpolation of the maximal penalty, relative to the time since the time of the last story which applies. For example, if the system has an Entity match that was 3 minutes ago, the demotion would be 175.0 points. If the Entity match was 6+ minutes ago, the demotion would be zero. For cases where multiple demotions apply, the system applies the single largest demotion available. To compute these demotions, the system only needs to know the last time when a particular Story Type, Entity and {Story Type, Entity} pair was added to the timeline. Thus this information can be stored efficiently in one of three hash value tables, and looked up very quickly.

Individual story demotions are efficient to compute and easy to understand, since they are necessarily demoted based on a single recent story, and all of the demotions are based on just several constants, which can be tweaked by hand or trained algorithmically to increase or decrease writing volume, to increase the diversity of Entities and Story Types, etc. The system creates several different live game timelines with different properties, by modifying the demotion constants for these timelines, as described further below.

The goals of the iterative timeline are to cover the game comprehensively through regular live updates, but also to aim for a total throughput (number of total updates per game). For example, Twitter only allows 125 updates during a four hour period, so the algorithm for a Twitter timeline must shoot to cover each game in about 100 updates. For an instant replay of a finished game, users want to see the game summarized as efficiently as possible, so the system shoots for 20-50 updates. On the other hand, when following a game live, a user doesn't want to stare at an unchanging screen for too long. The system aims to write a new story every 30-90 seconds of real time, and thus to cover the overall game in ^{˜}150 updates.

It is trivial to meet the expected output rate requirements by writing the “best story” at regular intervals, say every five minutes or four times a quarter. However, this makes for a poor system. For each of the above timelines, the user also expects to see the most interesting game stories covered, as they take place, regardless of the overall output rate. If there is a scoring run happening right now, a comeback by one team, a buzzer-beating shot or a historical performance, the user wants to see that story, regardless of output schedule.

Therefore, instead of outputting at regular intervals, the system can write stories to the timeline at any point of the game, while also maintaining a “minimum score cutoff” at each point in time, such that only stories scoring above that cutoff are eligible to be written, and: no major stories are missed by the timeline; the total number of stories for the game stick close to that timeline's desired range; and the pace of writing is consistent throughout the game. At a high level, the system adjusts the minimum cutoff for writing stories at each point in time, raising that cutoff right after the system writes a story, and gradually lowering it as the system goes through time and no new stories are written. If the system is ahead of pace or behind pace for the overall game output rate, the system adjusts how high the game goes up and how quickly it's lowered. The “can't miss” stories will always make it over the gate, while less crucial stories only make it over the gate if there has not been anything written right beforehand, or if the system is behind pace for the overall output rate for the game. A simple analogy might be “face control” at a nightclub. Rather than letting in the “best people” at regular intervals, the system demonstrates a continuous system that immediately lets in the high rollers, beautiful people, and celebrities, while letting in lesser customers at a gradual rate to fill in the expected crowd growth over the course of the evening. The fringe customers (or low-ranking stories in this case) might wait all night but never get in. The ordinary customers might get shut out on a night with too many celebrities and high rollers. Like a club that knows its capacity and how late it will be open, the system provides timing to control how many stories are added to each timeline between the starting tipoff and the final buzzer.

In step 316, the system uses a familiar linear interpolation technique to compute the “minimum score cutoff” for iterative writing. To compute this number, the system looks at three constants for that given timeline: (1) the maximum time allowed between stories, (2) the minimum score for writing a story immediately after another story has been written, and (3) the minimum score for writing a story after a long break between stories. For example, in a timeline meant to cover a game in 100-150 updates, the max time between stories can be set to 4:00, the and minimum story score between 275.0 and 525.0 (depending on the recency of the last story written). Thus if a story hasn't been written in 2:00 of game time, the minimum score for writing another story would be 425.0, the average of the high end and low end story writing cutoff. Of course, these score output gates are applied to stories which have already been demoted based on previously written stories.

In addition to the three numbers above, the high-end score output cutoff will be raised if the stories are being added to the timeline above the expected pace of writing. And similarly the high-end score output will be lowered if stories are being written significantly behind pace. For example, if currently on pace to write 150 stories, but only 100 stories are desired, then the high-end score output cutoff can be adjusted by 50%*100.0 story score points, where 100.0 is a constant, and the maximum by which the output gate would be adjusted in order to get closer to the expected output rate.

Note that really rare, important stories like Comeback:Epic will have starting story scores of 800.0+, thus easily clearing any output gate, as long as they are not strongly demoted by the “similar stories” system earlier. On the other hand, really common stories like TopOffensivePlayer will have base story scores as low as 250.0 before similar story demotion, so these stories will not clear the output gate unless there is nothing else to write about, and the system has not output a story in some time.

Just as importantly, the system controls the output rate and ensures that there are no lulls of zero output, through only four numbers per timeline: the max time between stories, the high and low end score cutoffs, and the maximum score cutoff adjustment based on the current output rate, compared to expected output rate. These values can be adjusted based on trial-and-error by re-generating output for previous game, or by training a machine learning system, also looking backward at what would have been the output for previous games.

Once a story meets the minimum writing cutoff, the system immediately adds it to the timeline under consideration. If the timeline allows writing multiple stories per iteration, the system adds those other stories, making sure that the first written stories are being used to consider story score demotions.

As long as the individual story scores correspond roughly to the relative importance of individual stories, the system can ensure diversity of stories and cover all of the most important stories, while staying near the desired number of total stories in each iteratively generated timeline. The system does so without requiring output at regular intervals, and without designating specific stories as “important to output” and others as “not important” in any sort of rigid way. Everything is done through individual story generation, scoring and score demotion. A new Story Generator or story type can be added and individual story scores adjusted, without having to change any code or cutoffs for timeline writing.

The algorithm can also be adjusted for cases where it is desired to generate a game timeline that is not needed live, e.g., a post-game or halftime summary. In such cases, the aforementioned greedy algorithm, which writes the best story at each point in time based on the previous stories, can be improved upon by also looking ahead to what stories could be written next. For example, if the Heat team are on an 8-0 run, such a timeline could look ahead to future generated stories to see whether the {ScoringRun, team:Heat} story will be generated in the next few iterations of the algorithm, at a higher story score. If so, that would indicate that the Heat increased their scoring run to 10-0 or to 12-2, thus making for a better version of the same story.

In such cases, the system can demote the score of the current version story, making it less likely to trigger, since a better story can be written by waiting. Importantly, this demotion is applied generically to all story types. It is not needed to write an “8-0 scoring run” story if a “10-0 scoring run” story will follow. Instead, the system can simply look ahead a few minutes of gametime, to see if the same exact {StoryType, Entity} story will have a higher score. The system does not prevent the story from triggering, but just makes it less likely to trigger, since a better version of the story will probably make it in the timeline in the next few iterations of the algorithm.

As noted, the system turns structured data into stories, and stories into iterative timelines, which cover the game live, for several different audiences at once, in a well-rounded, comprehensive and relevant manner. As seen in FIG. 4, the system can also input social media data 401, concurrently with the structured data about the game. This social media data is much less defined than the structured data, but it contains data that is not available in the play-by-play alone, as well as quotes from the different social media sources 402 that would be useful to insert into iterative timelines. These quotes enhance the game coverage, qualitatively, and by adding information that is not possible to process from the structured data alone.

Sets of good social media authors who have offered good in-game commentary for previous games are collected and organized on a per-team basis. These authors include professional reporters and beat writers, as well as team bloggers and the teams' official social media accounts. League-level sources such as writers with a national following who write live updates about many teams in the same league, as well as national bloggers, can also be collected. The system categorizes each writer, e.g., professional writer or a blogger, teams of expertise, etc. This information is useful to the machine learning system when scoring and interpreting individual writer's social media messages. The system may give more credence to a message by a source tagged as a professional writer, rather than a blogger. And for a national writer, the system may require more proof of relevance to an individual game, when considering a message that writer has posted, than for a message by someone known to be an expert about one of the teams playing. There are many games playing out concurrently. In finding the best, most relevant updates relevant to a specific game, it is useful to know what category of author wrote each message. For example, Bill Simmons (@SportsGuy33 on Twitter) is a national report for the NBA league; “Pippen Ain't Easy” is a blogger for the Bulls NBA team; the @Warriors Twitter account is an official account for the Warriors NBA team.

The system may be limited to a manageable hand-labeled number of (e.g., several thousand) accounts as possible social media sources. One of ordinary skill in the art could also determine a similar list of accounts with an automated system, however, be it a machine learning system looking for social media profile text and numbers of social media followers, or someone who finds lists of bloggers, team reports and official accounts for teams in each league, which other people have already built and published freely on the internet. The system applies not only to Twitter, but to social media content elsewhere, as long as it's possible to know the source of the message, and to get it in real-time during the game. For the sake of brevity, the terms “social media messages” and “tweets” are used interchangeably going forward.

Throughout the live game, the system checks for tweets from the relevant list of sources, namely all sources for both teams (professional writers for each team, bloggers for each team, official sources) as well as all of the national sources for that league (national bloggers, professional national writers, and official league-level sources). For each message, the system receives the message text, the message's author (and thus the previously labeled writer category), as well as the time that this message was posted. From the message text, the system extracts the known game entities mentioned in the text (players, teams and coaches), the game score if it is present, the game time if it is present, and the known basketball terms that the system is looking for. The system keeps track of thousands of terms and phrases related to live commentary on basketball games.

At step 406, using player data 403 and team data 404, the system parses each tweet for the purpose of recognizing numerous (e.g., over a hundred) terms that might be used to describe players, coaches, and teams for that given game. These terms include nicknames and partial or modified names. Teams and popular players commonly have as many as 5-20 ways of referring to that entity in a way recognizable to fans. The system aims to recognize all of these names, and in some cases, re-writes tweets to use a more canonical entity name, so that readers can more easily understand the entity reference. For example, hashtags and Twitter account names are routinely used to refer to specific players and teams. A simple name recognition system will not know that @KDTrey5 in a tweet refers to NBA player Kevin Durant. The system preferably not only knows that this is an equivalent name for this player, however, but also has the capability of re-writing that tweet to use the player's full name.

The system also looks for numerous (e.g., thousands of) terms within each tweet that are related to describing basketball games on social media. The system labels these terms by category, such as terms used to describe specific game plays (dunks, passes and rebounds), to describe player performance, and to give updates on player injuries. It would be very slow and computationally inefficient to look for each of these terms with a regular expression. Instead, each social media text can be pre-processed (cleaned up), and then the Aho-Corasick search algorithm applied to it, with an Aho-Corasick tree built with all of the e.g., thousands of terms, as well as the e.g., hundreds or more terms used to recognized Entities. The Aho-Corasick algorithm rapidly matches large numbers of exact text substrings in a piece of text. For example, the algorithm is used by Google Documents to efficiently match thousands of text substrings and classify documents into high-level categories. The algorithm requires that exact strings be matched, so terms like “game” need to be expanded to all of their equivalent conjugations and synonyms, like “games,” “match,” and “gamer.” The algorithm also requires removal of all punctuation from the input text (social media message), as well as any hashtags, non-alphabetic characters or capitalizations.

For a player name, the system analyzes the parsed text data 407 for all of the known versions of the name (processing lower-case text and ignoring punctuation), though not all matches result in a full (1.0) match score. Taking Kevin Garnett as an example, “kevin garnett” is a 1.0 match; “kevin” is a 0.3 match; “garnett” is a 0.5 match, “kg” is a 0.8 match (since it's a commonly known nickname for the player), and “realkevingarnett” is also a 0.8 match (since it matches the player's known Twitter account). Known nicknames and players' Twitter accounts are listed for all top league players on public websites such as http://basketballreference.com/ as well as other easy to find sources. Care is taken to reduce the match score for partial player names that are very common (James, John, Johnson) as well as those that match common English words (Wear, Rose, Best). These words can be found on any public list of common English words, or top internet search words. Similarly, the system builds lists of equivalent team names, including the official name, commonly used team names, the name of the city, and the team's Twitter account. “Celtics,” “Celts,” “C's,” and “Boston” are among the names that match the NBA team Boston Celtics.

Looking at hundreds of past tweets about basketball games, a lengthy (e.g., thousands) categorized list of relevant terms 405 can be compiled, which helps the system parse the information content of future basketball tweets. Thus from matching these terms, the system can get scores for matching any of several categories of information, including “injury,” “emotion,” “specific event,” and “player description.” Any term the system finds in the tweet that matches a term associated with said category will increase the match score for that category. The system also considers the term length (in words) to determine how much to increase the category match score from individual matches. Words that are too common or too ambiguous are excluded from the list. For example, the terms “ice wrap” and “ice pack” will match for category “injury” with a score of 0.5. The terms “smoking” and “smart” will match for the category “emotion” with a score of 0.2. The terms “pump fake” and “finger roll” will match for the category “specific event” with a score of 0.5. Terms “freshman,” “forward,” and “big man” match for the category “player description” with scores of 0.2, 0.2 and 0.5. The following table sets forth a categorized list of terms for use in the present embodiment of the system:

EMOTION
a dagger, achilles heel, achilles heels, aggression, aggressive, aggressively, aggressiveness,
aggressor, aggressors, all over, always, anger, angered, angrier, angriest, angry, animated, answer,
answered, answering, answers, asleep, assert, asserted, asserting, assertive, asserts, attack, attack
mode, attacked, attacking, attacking mode, attacks, attitude, awake, bad blood, bad start, battle,
battled, battling, bearing down, beast, beast mode, believable, believe, believed, believes, bumpy,
calm, calm down, calmed, calmed down, calming, calming down, calmly, can't, capitalize,
capitalized, capitalizes, capitalizing, care, caring, carried, carries, carrying, catch a break, caught a
break, caught break, change game, change the game, changed game, changed the game, changes
game, changes the game, changing game, changing the game, chippy, clutch, cold, cold blood, cold
blooded, composed, composure, consistent, consistently, cool down, cool off, cooled down, cooled
off, cooling down, cooling off, cools down, cools off, counter, countered, countering, counters,
courage, crafty, critic, critical, critically, criticize, criticized, criticizes, criticizing, critics, crucial,
curtains, dagger, daggers, dail in, dailed in, dare, dared, dares, daring, difference, differences,
different, disconcerting, disconcertingly, disgust, disgusted, disgusting, disgusts, downer, downers,
drama, dramatic, easily, easy, efficient, efficiently, encourage, encouraging, energize, energized,
energizing, energy, execute, executed, executes, executing, execution, exposed, exposing, fabulous,
factor, fail, failed, failing, fails, feel, feelin it, feelin' it, feeling, feeling it, felt, fire up, fired up, fires
up, firing up, flunk, flunked, flunking, flunks, focus, focused, focusing, force, forced, forceful,
forcefully, forces, forcing, fortunate, fortunately, frustrate, frustrated, frustrating, game change,
game changer, game changes, game changing, game face, gave up, get exposed, getting exposed,
give up, given up, gives up, giving up, glared, glares, glaring, good start, got exposed, great start,
guts, gutsy, gutty, have trouble, having trouble, havoc, heads up, his face, hug, hugged, hugging,
hugs, humming, humming along, hustle, hustled, hustling, ice, iced, ices, icing, impersonating,
impersonation, impress, impressed, impresses, impressive, impressively, improbable, improbably,
inconsistent, inconsistently, incredible, incredibly, intelligent, intelligently, intense, intensity,
intimidate, intimidated, intimidates, intimidating, jitters, just fine, kill, killer, killers, killin, killing,
kudos, last long, lasted a long, lasted long, lasting a long, lasting long, lasts a long, lasts long, lazier,
laziest, lazy, lethargic, light up, lighting up, lights out, lights up, like butter, lit up, long, long last,
look for, look out, loong, looong, mind frame, mind frames, mind set, mind sets, missed chance,
missed chances, mistake, mistaken, mistakes, momentum, monster, motivate, motivated,
motivates, motivating, murder, murdered, murdering, murders, my face, need, needed, needs,
never, nifty, nimble, nimbler, non existent, not realistic, on fire, on his back, on my back, out hustle,
out hustled, out hustles, out hustling, out of control, out play, out played, out playing, outhustle,
outhustled, outhustles, outhustling, outplay, outplayed, outplaying, over came, over come, over
coming, overcame, overcome, overcoming, pep, phenom, phenomenal, poor start, powerful,
prepared, pretend, pretender, pretenders, pretending, pretends, problem, problematic, problems,
ran away, ran out, rattled, ready, ready to go, realistic, remind, reminded, reminding, reminds,
respond, responded, responding, responds, response, ripping, rout is on, rout was on, routing, run
away, run out, running away, running out, rust, rusty, school, schooled, schooling, scramble,
scrambled, scrambles, scrambling, scream, screamed, screaming, screams, seize momentum, seize
the moment, seized momentum, seized the moment, seizing momentum, seizing the moment,
selfish, selfishly, shakier, shakiest, shaky, sharp, sharper, shout, shouting, shouts, show up, showed
up, showing up, shows up, shred, shredded, shredding, shreds, shut down, shuts down, shutting
down, sleeping, sleepy, slo mo, slo motion, slomo, sloppy, sloppy game, slow mo, slow motion,
slowmo, sluggish, smart, smarter, smarting, smarts, smile, smiled, smiles, smiling, so many, so
sharp, solid, solidly, spectacle, spectacular, stare, stare down, stared, stared down, staredown,
staredowns, stares, stares down, staring, staring down, stink, stinks, strategic, strategy, strength,
strengths, strong, stronger, strongest, struggle, struggled, struggles, struggling, stunk, take
advantage, take control, taking advantage, taking control, taking over, talk trash, talking trash, talks
trash, taunt, taunted, taunting, taunts, temper, tempers, terrific, testy, the dagger, threat,
threaten, threatened, threatening, threatens, threats, too easily, too easy, too many, too tight,
took advantage, took control, took over, trap game, trap games, trouble, troubles, troubling, ugly
game, unbelievable, unfortunate, unfortunately, unglued, unreal, unrealistic, very sharp, wake up,
waking up, watch for, watch out, weakness, weaknesses, when ever, whenever, where ever,
whereever, woke up, won't, work, worked, working, works, x factor, yell, yelled, yelling, yells
FOUL_EVENT
1 & 1, 1 & 1s, 1 and 1, 1 and 1s, 2 techs, 3 techs, a tech, and 1, and harm, and one, bad call, bad
calls, blown call, blown calls, called for, charge, charges, cheap foul, cheap fouls, draw contact,
drawing contact, draws contact, drew contact, ejected, first tech, flagrant, flagrant 1, flagrant 2,
flagrant one, flagrant two, flop, flopped, flopping, flops, forced to foul, foul, foul call, foul called,
foul calls, foul on, foul to give, fouled, fouling, fouls, fouls call, fouls called, fouls calls, fouls to give,
get away, get away with, get called for, get to the line, gets called for, gets fouled, gets to the line,
getting to the line, got away, got away with, got tossed, hack, hacked, hacking, hacks, hard foul,
hard fouls, has to foul, have to foul, in bonus, in the bonus, joey crawford, no call, non call, non
calls, off foul, off fouls, offensive foul, offensive fouls, official, officials, officiated, officiating, one
and one, one and ones, over limit, over the limit, pick up a t, pick up a tech, picked up a t, picked up
a tech, picks up a t, picks up a tech, push, pushed, pushes, pushing, reach foul, reach fouls, ref,
referee, referees, refs, shove, shoved, shoves, shoving, t'ed up, tech, technical, technicals, techs,
time to foul, tossed, tough call, tough calls, tough foul, tough fouls, was fouled, whistle, whistled,
whistles, whistling, without fouling
LINKS
82games, blog, blogger, bloggering, bloggers, blogs, chat, comment, comments, espn, facebook, fb,
ff, follow, follower, followers, following, game thread, gamethread, grantland, highlight, highlights,
http, internet, laptop, link, links, recap, t.co, ticket, tickets, time line, timeline, tix, tune in, twitter,
typing, via, wifi, writer, writers, youtube
SPECIFIC_EVENT
1-3-1 zone, 2 handed, 2 handed dunk, 2-3 zone, 2nd chance, 2nd chances, 3 point play, 3 pt play, 3
second, 3 seconds, 3-2 zone, 3pt play, 4 point play, 4 pt play, 4pt play, a oop, against the zone,
against zone, air ball, air balls, airball, airballs, all ball, alley oop, alley oops, an oop, another 3,
another basket, another bucket, another shot, another steal, another three, another to, another
turnover, at the rim, attack rim, attack the boards, attack the paint, attack the rim, attacked rim,
attacked the rim, attacking rim, attacking the rim, attacks rim, attacks the boards, attacks the paint,
attacks the rim, back door, back door cut, back door cuts, back door screen, back door screens,
back him down, back him up, back on d, back on defense, back to back, backdoor, backdoor cut,
backdoor cuts, backdoor screen, backdoor screens, backed down, backed him down, backed him
up, backed up, backing down, backing him down, backing him up, backing up, backs down, backs
him down, backs him up, backs up, bad d, bad decision, bad decisions, bad pass, bad passes, bad
passing, bad possession, bad possessions, bail out, bailed out, bails out, ball movement, ball screen,
ball screens, banked, banked in, banks in, base line, base line jumper, base line jumpers, baseline,
baseline drive, baseline drives, baseline jumper, baseline jumpers, beyond the arc, blew by, blew
past, block from behind, block out, blocked from behind, blocked out, blocking out, blocks from
behind, blocks out, blow by, blow past, blowing by, blowing past, blows by, blows past, bounce,
bounce pass, bounce passes, bounce passing, bounced, bounces, break an ankle, break ankles,
break away, break aways, breakaway, breakaway dunk, breakaway dunks, breakaway slam,
breakaway slams, breakaways, breaking an ankle, breaking ankles, brick, brick out, bricks, bricks
out, bullet, bullet pass, bullet passes, buried, buried a, buries, buries a, cans a, careless pass,
careless passes, careless passing, catch & shoot, catch and shoot, caught up, circus shot, circus
shots, clang, clangs, clank, clank out, clanking, clanking out, clanks, clanks out, clock violations,
close out, closed out, closes out, closing out, clutch bucket, clutch shot, clutch three, clutch trey,
coast 2 coast, coast to coast, corner 3, corner for 3, corner for three, corner for trey, corner three,
corner trey, court vision, court visions, crash the boards, crash the glass, crashed the boards,
crashing the boards, crazy shot, crazy shots, create a shot, create shots, created a shot, created
shots, creates a shot, creates shots, creating a shot, creating shots, cross over, cross overs,
crossover, crossovers, curl, curls, d up, deep 2, deep 3, deep three, deep two, defensive battle,
defensive battles, defensive struggle, defensive struggles, deflect, deflected, deflection, deflections,
deflects, difficult shot, difficult shots, distribute, distributed, distributes, distributing, distributor,
distributors, double dribble, double dribbled, double dribbles, double dribbling, double team,
double teamed, double teaming, double teams, down court, down floor, down low, down the
court, down the floor, drain, drain a, drained, drained a, drains, drains a, draw a charge, draw
contact, draw the charge, drawing a charge, drawing contact, drawing the charge, draws a charge,
draws contact, draws the charge, drew a charge, drew the charge, dribble penetration, drive &
dish, drive & kick, drive and dish, drive and kick, drive baseline, drive the lane, drive to the basket,
drive to the hoop, drive to the rim, drives baseline, driving the lane, driving to the basket, driving to
the hoop, driving to the rim, dropped the ball, drops the ball, drove the lane, drove to the basket,
drove to the hoop, drove to the rim, dub team, dub teamed, dub teaming, dub teams, dunk in
transition, dunked on, dunked over, dunking on, dunking over, dunks on, dunks over, easy dunk,
easy dunks, elbow, elbow area, elbow j, elbow js, elbow jumper, elbow jumpers, elbowed,
elbowing, elbows, entry, entry pass, entry passes, entry passing, euro step, euro stepped, euro
stepping, euro steps, eurostep, eurostepped, eurostepping, eurosteps, facial dunk, facial dunks,
facial jam, facial jams, facial slam, facial slams, facilitate, facilitated, facilitates, facilitating,
facilitator, facilitators, fade away, fade away 3, fade away three, fadeaway, fadeaway 3, fadeaway
three, fading away, fake, faked, fakes, faking, fast pace, fast paced, faster pace, faster paced,
feeding, feeds, finger roll, finger rolls, fingerroll, fingerrolls, floated, floater, floats, follow through,
follow thru, follows through, follows thru, foot jumper, foot jumpers, foot on line, foot on the line,
foot shot, foot shots, foot was on the line, four point play, four pt play, from behind, from deep,
from down town, from downtown, from waaay downtown, from waay downtown, from way
downtown, ft jumper, ft jumpers, ft shot, ft shots, full court, full court press, full court pressure, full
courts, fumble the ball, fumbled the ball, fumbles the ball, give away, give aways, giveaway,
giveaways, glacial pace, glacial paced, go base line, go baseline, go zone, goal tend, goal tending,
goaltend, goaltending, goes base line, goes baseline, goes zone, going zone, good decision, good
decisions, good dish, good pass, good passes, good possession, good possessions, got caught, half
court, half courts, halfcourt, halfcourt shot, halfcourt shots, hand check, hand checked, hand
checking, hand checks, hand dunk, hand dunks, hand jam, hand jams, hand slam, hand slams,
handed dunk, handed dunks, handed jam, handed jams, handed slam, handed slams, he's open,
help d, help defense, help for, help on, help out, hi post, hi screen, hi screens, hi top fade, hi top
fadeaway, high percent, high percentage, high percentage shot, high percentage shots, high post,
high screen, high screens, high top fade, high top fadeaway, hits iron, hook shot, hook shots,
impossible shot, impossible shots, in front, in front of, in rhythm, in the paint, in the post, in traffic,
in transition, inside move, inside moves, iron, iso, isolated, isolation, jab step, jab steps, jabstep,
jabsteps, just iron, kick out, kicked out, kicks out, knock down, knock it down, knock that down,
knocked down, knocked it down, knocked that down, knocking down, knocking it down, knocking
that down, knocks down, knocks it down, knocks that down, lane violation, lane violations, leaning
3, leaning three, left hook, left hooks, lefty hook, lefty hooks, lightning pace, lightning paced, lo
post, lo screen, lo screens, long 2, long range, long reb, long rebound, long rebounds, long rebs,
long two, loses the ball, lost the ball, low post, low screen, low screens, It hook, It hooks, man d,
man defense, massive slam, massive slams, match up zone, matchup zone, mid air, mid court, mid
range j, mid range jumper, mid range shooter, mid range shooters, mid range shot, mid range
shots, midair, midcourt, midrange j, midrange jumper, midrange shooter, midrange shooters,
midrange shot, midrange shots, milk the clock, milked the clock, milking the clock, milks the clock,
monster dunk, monster dunks, monster jam, monster jams, monster slam, monster slams, moving
screen, moving screens, nba range, nice dish, nice pass, nice passes, nifty move, nifty moves, o
board, o boards, o reb, o rebs, off a screen, off board, off boards, off glass, off rebound, off
rebounding, off rebounds, off screen, off screens, off the dribble, offensive board, offensive boards,
offensive glass, offensive rebound, offensive rebounding, offensive rebounds, on the block, only
iron, open 3, open 3s, open court, open courts, open dunk, open dunks, open for 3, open for three,
open guy, open guys, open man, open men, open slam, open slams, open space, open spaces, open
three, open threes, open trey, open treys, oreb, orebs, out of bounds, out of rhythm, outlet, outlet
pass, outlet passes, outlet passing, over screen, over screens, over the screen, over the screens,
p&r, p&rs, pace, pacing, paint, paint points, penetrate, penetrated, penetrates, penetrating,
penetration, perimeter, perimeter move, perimeter moves, perimeter shooter, perimeter shooters,
perimeter shooting, perimeter shot, perimeter shots, pick & pop, pick & roll, pick & rolls, pick and
pop, pick and roll, pick and rolls, pick pocket, pick pockets, picked pocket, picked pockets, picks
pocket, picks pockets, play book, play call, play calls, playbook, playing man, playing man d, playing
zone, playing zone d, pnr, pnrs, pocket picked, points in paint, poor decision, poor decisions,
possession, possessions, post game, post move, post moves, post up, posted up, poster dunk,
posting up, posts up, press full court, pressing, pressure full court, pretty move, pretty moves,
pretty pass, pretty passes, pretty shot, pretty shots, princeton offense, pull up, pull up jumper,
pulled up, pulling up, pump fake, pump faked, pump fakes, pump faking, push ball, push pace, push
the ball, push the pace, pushed ball, pushed pace, pushed the ball, pushed the pace, pushes ball,
pushes pace, pushes the ball, pushes the pace, pushing ball, pushing pace, pushing the ball, pushing
the pace, put back, put backs, putback, putbacks, quick 3, quick 3s, quick basket, quick baskets,
quick bucket, quick buckets, quick decision, quick decisions, quick move, quick moves, quick
release, quick releases, quick shot, quick shots, quick three, quick threes, quick trey, quick treys,
recover, recovered, recoveries, recovering, recovers, recovery, reverse dunk, reverse dunks,
reverse jam, reverse jams, reverse layin, reverse layins, reverse layup, reverse layups, reverse slam,
reverse slams, rhythm, right hook, right hooks, righty hook, righty hooks, rim out, rims out, rotate,
rotated, rotates, rotation, rotations, rt hook, rt hooks, ruled a 2, ruled a 3, ruled a three, ruled a
two, run by, run the court, run the floor, running hook, running the court, running the floor, runout,
runouts, runs by, runs the court, runs the floor, scoop shot, scoop shots, screen, screen & roll,
screen & rolls, screen and roll, screen and rolls, screen roll, screen rolls, screened, screens, second
chance, second chances, separation, sequence, sequencing, shake & bake, shake and bake, shoot
out, shoot outs, shooter, shooters, shootout, shootouts, short range, shot clock violation, shot
clock violations, shot selection, shot selections, shotclock violation, shotclock violations, shots
selection, shovel a pass, shovel pass, shovel passes, shovels a pass, shovels pass, shovels passes,
skip pass, skip passes, skip passing, sky hook, sloppy pass, sloppy passes, sloppy passing, slow pace,
slow paced, slow the pace, slower pace, slower paced, slowing the pace, soft d, soft hook, soft
hooks, space, spaces, spacing, spin move, spin moves, spot, spot up, spot ups, spots, spotup,
spotups, step around, step back, step back 3, step back three, step back trey, steparound, steps
around, stifling d, stifling defense, stifling on d, stifling on defense, stroke, stroke a, stroked,
stroked a, strokes, strokes a, stroking, stroking a, strong d, strong side, take away, take aways,
takeaway, takeaways, tear drop, tear drops, teardrop, teardrops, tempo, the block, the corner, the
corners, the glass, the key, the lane, the oop, the paint, the perimeter, the post, the press, the put
back, the rim, the tempo, the window, three point play, three pt play, three second, three seconds,
threw down, threw it down, throw down, throw it down, throws down, throws it down, tip in, tip
ins, tipin, tipins, tipped, tipped in, tips in, tips it in, to rim, top of the key, touch, touches, tough d,
tough defense, tough on d, tough on defense, tough shooting, tough shot, tough shots, transition,
transition dunk, turn around, turn around j, turn around jumper, turn around jumpers, turn around
shot, turn around shots, turnaround, turnaround j, turnaround jumper, turnaround jumpers,
turnaround shot, turnaround shots, two handed, two handed dunk, under screen, under screens,
under the screen, under the screens, underneath, up & under, up & unders, up and under, up and
unders, up tempo, uptempo, versus the zone, violate, violation, violations, vision, vs the zone, weak
side, wide open, wide open 3, wide open 3s, wide open three, wide open threes, wide open trey,
wide open treys, wild shooting, wild shot, wild shots, windmill dunk, window, work inside, work it
inside, work the clock, worked inside, worked it inside, worked the clock, working inside, working it
inside, working the clock, works the clock, zone d, zone defense
PLAYER_DESCRIPTION
+/−, 0 boards, 0 for, 0 free throw, 0 free throws, 0 ft, 0 fts, 0 of, 0 points, 0 pts, 0 rebounds, 0 rebs, 0
shots, 1 for, 1 of, 1st unit, 1st units, 2 fouls, 2 guard, 2 guards, 2 pf, 2 pfs, 2nd foul, 2nd unit, 2nd
units, 3 fouls, 3 guard, 3 guard lineup, 3 guards, 3 pf, 3 pfs, 3 point shooter, 3 point threat, 3 pt
shooter, 3 pt threat, 3rd foul, 4 fouls, 4 guard, 4 guard lineup, 4 guards, 4 pf, 4 pfs, 4th foul, 5 fouls,
5 pf, 5 pfs, 5th foul, 6′10, 6′11, 6′7, 6′8, 6′9, 6th foul, 6th man, 7 feet, 7 footer, 7 footers, 7′0, 7′1,
7′2, a rest, abilities, ability, adjust, adjusted, adjustment, adjustmentment, adjustmentments,
adjustments, adjusts, all around, all around game, athlete, athletes, available player, available
players, back in, bad game, bad player, bad players, ball handler, ball handlers, ballhandler,
ballhandlers, basketball iq, bench, bench mob, bench player, bench players, benches, best
defender, best defenders, best game, best player, best players, big guy, big guys, big line up, big
line ups, big lineup, big lineups, big man, big men, big minutes, bigger line up, bigger line ups,
bigger lineup, bigger lineups, bigness, bigs, both ends, box score, breather, breathers, came in,
came out, can't stop, captain, captains, career, career best, career first, career hi, career high,
career highs, career lo, career low, career lowest, career lows, career worst, center, centers, check
back in, check in, checked back in, checked in, checking back in, checking in, checks back in, checks
in, chime in, chimed in, chiming in, co captain, co captains, comes in, comes out, conf history, conf
record, conf records, conference history, conference record, conference records, contribute,
contributed, contributes, contributing, dbl dbl, dbl dbls, doing it all, double double, double doubles,
early action, early minutes, early run, early sub, early subs, early substitution, early substitutions,
exhausted, exhausting, exhaustion, experience, experienced, fatigue, fatigued, fifth foul, first
career, first unit, first units, five fouls, forwards, foul out, foul trouble, fouled out, fouling out, fouls
out, four fouls, four guard, four guards, fourth foul, franchise history, franchise record, franchise
records, freshman, freshmen, from bench, from the bench, frosh, game hi, game high, gassed, go
big, go small, goes big, goes out, goes small, going big, going small, good game, good minutes, good
player, good players, got going, great game, his career, historic, history, hoop iq, hoops iq, hurt his
team, hurt the, hurt the team, hurting his team, hurting the, hurting the team, in foul trouble, in
the game, inexperience, inexperienced, iq, lead rebounder, lead rebounders, lead scorer, lead
scorers, lead the way, leading rebounder, leading rebounders, leading scorer, leading scorers, leads
the way, league history, league record, league records, left hand, left handed, line up, line ups,
lineup, lineup change, lineup changes, lineups, lock in, locked in, locking in, locks in, major minutes,
match up, match ups, matchup, matchups, mis match, mis matched, mis matching, mismatch,
mismatched, mismatching, nba history, nba record, nba records, nice game, no boards, no free
throw, no free throws, no ft, no fts, no points, no pts, no rebounds, no rebs, no shots, not talented,
o for, off bench, off pine, off the bench, off the pine, oh for, olympic record, olympic records,
olympics record, olympics records, on his back, on the board, out of gas, out of shape, pf, pfs, pg,
pgs, pick up, picked up, picking up, picks up, pitch in, pitched in, pitching in, play big, play small,
playing along side, playing alongside, playing big, playing small, playing with, point forward, point
guard, point guards, power forward, power forwards, rested, rests, rook, rookie, rookies, rooks,
roster, sat down, season hi, season high, season highs, season lo, season low, season lows, second
foul, second unit, second units, senior, seniors, sf, sg, shooting guard, shooting guards, sits down,
sitting down, six fouls, sixth foul, sixth man, skill, skilled, skills, small forward, small forwards, small
line up, small line ups, small lineup, small lineups, smaller line up, smaller line ups, smaller lineup,
smaller lineups, some minutes, soph, sophomore, sophomores, sophs, spelled, spells, start, starter,
starters, starting 5, starting five, starting lineup, starts, stat line, stats, stop him, sub in, sub out,
subbed in, subbed out, subs in, subs out, support cast, supporting cast, suspended, suspesion, take
a seat, takes a seat, talent, talented, team history, team record, team records, the roster, third foul,
three fouls, three guard, three guards, three point shooter, three point threat, three pt shooter,
three pt threat, tired, tires, took a seat, triple double, triple doubles, tweener, tweeners, two fouls,
two guard, two guards, untalented, vet, veteran, veterans, vets, walk on, walk ons, walkon,
walkons, well rested, went big, went out, went small, wing, wing span, wing spans, wings,
wingspan, wingspans, worst player, worst players, youth, youthful, zero for
RETWEET
account, mrmichaelee, mt, retweet, retweets, roll call, rt, text, texts, trending, tweep, tweeps,
tweet, tweeted, tweeting, tweets, twitterverse, wbb
CHEERING
applaud, applauding, applause, arena, atmosphere, awesome, big cheer, big ovation, bleachers,
boo, booing, boos, brutal, can't miss, chant, chanted, chanting, cheer, cheered, cheering, cheers,
come on, crazy, crowd, crowded, crowds, empty seats, erupt, erupted, erupting, erupts, fan, fan
base, fan bases, fanbase, fanbases, fans, get going, get her going, get him going, get it going, get it
together, get something going, gets it going, gets it together, getting going, getting her going,
getting him going, getting it going, getting it together, getting something going, go go, go nuts,
going nuts, good job, got her going, got him going, got something going, great job, hang on, hang
on tight, hang tight, have fun, having fun, heckle, heckled, heckler, heckles, heckling, here we go,
home white, home whites, hope, hoping, i hope, in awe, insane, insanely, its feet, jumbotron, let's
go, let's hope, let's see, lets go, loud, louder, noise, noises, noisy, out of his mind, ovation,
posterize, posterized, posterizes, posterizing, pump up, pumped up, pumping up, rafters, rise up,
riseup, road blue, road blues, standing o, standing ovation, stands, step up, stepped up, stepping
up, student section, the arena, the building, the crowd, the roof, the seats, their feet, thunderous,
went nuts
SCORE
against the spread, away team, back within, ball game, biggest lead, blow it open, blowing it open,
blows it open, claw back, clawed back, clawing back, claws back, come back, comeback,
comebacks, coming back, cover, covered, covers, cruise, cruising, cut lead, cut the deficit, cut the
lead, cuts lead, dbl digit, dbl digits, dbl figure, dbl figures, deficit, deficits, dog, double digit, double
digits, double figure, double figures, down 1, down 2, down 3, down 4, down 5, down 6, down 7,
down 8, down 9, down eight, down five, down four, down nine, down one, down seven, down six,
down three, down two, drain both, drained both, drains both, favorite, final-, final:, first bucket,
first fg, first field goal, first lead, first loss, first points, first win, game over, game tied, has the ball,
hi scoring, high scoring, hit both, hits both, hold on, holding on, home team, is over, it's over, large
lead, largest lead, last play, last plays, last possession, last possessions, lead to, lo scoring, low
scoring, made both, makes both, missed both, missed first, missed second, missed the first, missed
the second, misses both, misses first, misses second, misses the first, misses the second, moral
victories, moral victory, out score, out scored, out scores, out scoring, outscore, outscored,
outscores, outscoring, point dog, point favorite, point lead, point leads, point swing, point swings,
point underdog, possession arrow, pt dog, pt favorite, pt lead, pt leads, pt swing, pt swings, pt
underdog, pull back within, pull within, pulls back within, pulls within, quick points, quick pts, quick
score, quick scores, quick scoring, retake lead, retake the lead, retaken lead, retaken the lead, score
less, scoreless, take lead, take the lead, taken lead, taken the lead, takes lead, takes the lead, taking
lead, taking the lead, the deficit, tie, tie game, tied, tied at, tied game, tied up, tied up at, ties,
tough loss, trail, trailed, trailing, trails, tying, underdog, up 1, up 2, up 3, up 4, up 5, up 6, up 7, up 8,
up 9, up eight, up five, up four, up nine, up one, up seven, up six, up three, up two, victory, win,
winning, wins, with the ball, within 1, within 2, within 3, within 4, within 5, within five, within four,
within one, within three, within two
TIME_NARRATIVE
1st h, 1st half, 1st quarter, 1stq, 2nd h, 2nd half, 2nd quarter, 2ndq, 2nite, 2ot, 3rd quarter, 3rdq,
4th quarter, 4thq, after noon, afternoon, all afternoon, all day, all night, all nite, all season, already,
as long, at half, at half time, at halftime, at the half, ball game, burn a timeout, burn timeout, burns
a timeout, burns timeout, buzzer, double ot, down the stretch, earlier, early, end 1st, end 2nd, end
3rd, end 4th, end of 1st, end of 2nd, end of 3rd, end of 4th, end of the 1st, end of the 2nd, end of
the 3rd, end of the 4th, evening, fast start, fast starter, fast starts, final t/o, final time out, final
timeout, final to, first half, first halves, first quarter, fourth quarter, full time out, full timeout, game
1, game 2, game 3, game 4, game 5, game 6, game 7, game time, games 1, games 2, games 3,
games 4, games 5, games 6, games 7, half time, halftime, halves, in 1st, in 2nd, in 3rd, in 4th, in
regulation, in the 1st, in the 2nd, in the 3rd, in the 4th, in the half, last meeting, last mtg, last
season, last timeout, last to, long time, media t/o, media time out, media timeout, media to, mid
1st, mid 2nd, mid 3rd, mid 4th, mid first, mid fourth, mid second, mid third, mid through, mid thru,
midway through, midway thru, min, min ago, min left, minute, minutes, minutes ago, minutes left,
next season, next time, now, of regulation, official t/o, official timeout, official to, open game, open
the game, opens game, opens the game, ot, out of the gate, out the gate, over time, overtime, pre
game, pregame, remaining in, sec left, sec to play, second half, second halves, second left, second
quarter, second to play, seconds left, seconds remaining, seconds to play, secs left, secs to play,
slow start, slow starter, slow starts, so far, so long, the 1st, the 2nd, the 2nd half, the 3rd, the 4th,
the buzzer, the day, the half, the horn, third quarter, this evening, this half, this quarter, this
season, thus far, time out, time outs, timeout, timeouts, to go, to start, to start the game, today,
tonight, tonite, too long, tv t/o, tv time out, tv timeout, tv to, under way, underway
GENERAL_EVENT
1 & 1, 1 & 1s, 1 and 1, 1 and 1s, 2 techs, 3 ball, 3 balls, 3 point, 3 pointer, 3 pointers, 3 pt, 3 ptr, 3
ptrs, 3 techs, 3p, 3pt, 3ptr, 3ptrs, 3s, a stop, a tech, a travel, and 1, and harm, and one, are falling,
aren't falling, assist, assisted, assists, ast, asts, attempt, attempts, back court, back end, back ends,
backcourt, bad d, bad defense, bad look, bad looks, bad play, bad shot, bad shots, bad take, bad
takes, ball, ball game, ball games, ball handler, ball in, ball inbound, ball inbounds, ballgame,
ballgames, balls, base line, baseline, basket, baskets, big play, big shot, big shots, block, block shot,
blocked, blocked shot, blocked shots, blocking shot, blocking shots, blocks, blocks shot, blocks
shots, boards, break down, break downs, breakdown, breakdowns, broke down, broke downs,
bucket, buckets, bunnies, called for, charge, charges, cheap foul, cheap fouls, chucking, contest,
contested, contesting, contests, court, courts, cut, cuts, dead ball, defend, defended, defender,
defending, defends, defense, defenses, defensive, defensively, dish, dished, dishes, dishing, dive,
dived, dives, diving, dribble, dribbled, dribbles, dribbling, drill, drilled, drilling, drills, drive, drives,
driving, drove, dunk, dunked, dunking, dunks, easy bucket, easy buckets, easy look, easy looks, easy
play, easy shot, easy shots, easy take, ejected, falling, fast break, fastbreak, fg, fg attempt, fg
attempts, fgs, field goal, field goals, first tech, flagrant, flagrant 1, flagrant 2, flagrant one, flagrant
two, flop, flopped, flopping, flops, foot work, footwork, for 3, for three, forced to foul, foul, foul
call, foul called, foul calls, foul on, foul to give, fouled, fouling, fouls, fouls call, fouls called, fouls
calls, fouls to give, free throw, free throw line, free throws, freebie, freebies, from field, from line,
from stripe, from the field, from the floor, from the line, from the stripe, front court, front end,
front ends, frontcourt, ft, ft line, fts, game, games, get away, get away with, get blocked, get called
for, get inside, get outside, get rejected, get stops, get the ball, get to the line, gets blocked, gets
called for, gets fouled, gets inside, gets outside, gets rejected, gets stops, gets the ball, gets to the
line, getting inside, getting outside, getting stops, getting the ball, getting to the line, gm, gms, go
inside, go outside, goes inside, goes outside, good d, good defense, good look, good looks, good
play, good shot, good shots, good take, good takes, got away, got away with, got blocked, got
rejected, got stops, got tossed, great d, great defense, great defensive, great look, great looks,
great play, great shot, great shots, great take, great takes, guard, guarding, guards, gunner,
gunners, gunning, hack, hacked, hacking, hacks, handle, handled, handler, handles, hard foul, hard
fouls, has to foul, have to foul, hit, hit a 3, hit it, hits, hits a 3, hits it, hitting, hitting it, hot hand, hot
hands, in bonus, in the bonus, inbound, inbound pass, inbounded, inbounding, inbounds, inbounds
pass, inside, inside out, j's, jam, jammed, jams, joey crawford, jump, jump shooter, jump shooters,
jump shot, jump shots, jumper, jumpers, jumps, jumpshot, jumpshots, last shot, last shots, lay in,
lay ins, layin, layins, layup, layups, length, loose ball, loose balls, making, miss, miss it, missed,
missed a 3, missed a ft, missed basket, missed bucket, missed ft, missed fts, missed hoop, missed it,
missed shot, missed shots, misses a 3, misses a ft, misses ft, misses fts, missing, missing a ft, missing
ft, missing fts, missing it, motion, motioned, motions, move, moved, movement, movements,
moves, next basket, next baskets, next bucket, next buckets, no call, non call, non calls, off foul, off
fouls, offense, offensive, offensive foul, offensive fouls, offensively, official, officials, officiated,
officiating, on clock, on floor, on the clock, on the field, on the floor, on the line, one and one, one
and ones, one end, other end, outside, over limit, over the limit, pass, passed, passer, passing,
physical, physically, pick, pick up a t, pick up a tech, picked up a t, picked up a tech, picks, picks up a
t, picks up a tech, play d, play defense, played, playing, plays, point, points, pop, pops, practice,
practiced, practices, practicing, pt, pts, push, pushed, pushes, pushing, reach foul, reach fouls, reb,
rebound, rebounded, rebounding, rebounds, rebs, ref, referee, referees, refs, rejected, run out, run
outs, running, runout, runouts, runs out, shoot, shooting, shoots, shot, shot attempt, shot
attempts, shot clock, shotclock, shots, shove, shoved, shoves, shoving, size, slam, slam dunk,
slamed, slams, slice, sliced, slicing, steal, steals, stole, stolen, stop, stopping, stops, strip, stripe,
stripped, stripping, strips, swat, swats, swatted, swatting, swing, swinging, swings, swung, t'ed up,
taking, tech, technical, technicals, techs, the 3, the ball, the basket, the boards, the clock, the d, the
field, the floor, the glass, the hoop, the jam, the line, the rock, three, three ball, three balls, three
pointer, three pointers, threes, time to foul, to line, to the line, to's, tos, tossed, tough call, tough
calls, tough foul, tough fouls, tough look, tough play, tough shot, tough shots, tough take, tough
takes, travel, traveled, traveling, travelled, travels, trey, treys, trick, tricked, tricking, tricks, tricky,
triple, triples, turn it over, turn the ball, turned it over, turned the ball, turning it over, turning the
ball, turnover, turnovers, turns it over, turns the ball, warm up, warmed up, warming up, warmup,
warmups, was fouled, whistle, whistled, whistles, whistling, will shoot, without fouling
INJURY
100 percent, a cast, a split, acl, ankle, ankle injury, ankle sprain, ankle tweak, ankles,
appendectomy, appendix, athletic trainer, available to return, back hurts, back on the court, back
out there, back spasm, back spasms, bad ankle, before he can return, bleeding, blood, bruise,
bruised, bum ankle, calf, cast, cleared to play, close to 100, coming back, contusion, contusions,
could limit him, cramp, cramped, cramping, cramps, cut finger, cut fingers, cut lip, diagnose,
diagnosed, diagnosis, did not return, dislocate, dislocate elbow, dislocated, dislocated elbow,
dislocates, dislocates elbow, dislocating, done for day, done for game, done for the day, done for
the game, doubtful to return, expected back, expected to be back, expected to return, expecting to
be back, expecting to return, expects to be back, expects to return, flu, foot injury, gingerly,
grimace, grimaced, grimaces, grimacing, head injury, health, healthy, her feet, her foot, herniated,
his back, his feet, his foot, hobbled, hobbles, hobbling, hurt, hurting, hurts, hurts her thumb, hurts
his thumb, hurts thumb, ice pack, ice packs, ice wrap, ice wraps, in a cast, in a split, injured, injuries,
injury, injury report, knee injury, knee sprain, l ankle, l foot, lacerated, laceration, left ankle, left
foot, left foot injury, left hand, leg injury, ligament, ligaments, limit him, limiting him, limping, limps
in, limps off, locker room , lockerroom, lt ankle, mcl, medical, medical report, medical reports, not
100, not feeling well, not returning, official injury, official injury report, patch up, patched up, pcl,
protective boot, protective boots, quad, quadriceps, quads, r ankle, r foot, receive treatment,
receive treatments, received treatment, received treatments, receives treatment, receives
treatments, receiving treatment, receiving treatments, right ankle, right foot, right foot injury, right
hand, rt ankle, serious injury, shoulder, sore calf, split, sprain, sprain acl, sprain ankle, sprain ankles,
sprain knee, sprain left, sprain ligament, sprain lt, sprain mcl, sprain pcl, sprain right, sprain rt,
sprained, sprained acl, sprained ankle, sprained ankles, sprained knee, sprained left, sprained
ligament, sprained lt, sprained mcl, sprained pcl, sprained right, sprained rt, sprains, stitches,
stomach flu, strain, straind calf, straind left calf, straind lt calf, straind right calf, straind rt calf,
strained, strained calf, strained left calf, strained lt calf, strained right calf, strained rt calf, strains,
tendon, tendons, to return, torn acl, torn ligament, torn ligaments, torn mcl, torn pcl, trainer,
treated for, treated for an injury, treated for injury, treated with, treating an injury, treatment, try
to return, tweak an ankle, tweak ankle, tweak his ankle, tweaked an ankle, tweaked ankle, tweaked
his ankle, tweaks an ankle, tweaks ankle, tweaks his ankle, twist ankle, twist ankles, twisted ankle,
twisted ankles, twists ankle, twists ankles, walking boot, walking boots, will not return, will return,
won't return, x ray, x rays, xray, xrays
FOUL_PLAYER
2 fouls, 2 pf, 2 pfs, 2nd foul, 3 fouls, 3 pf, 3 pfs, 3rd foul, 4 fouls, 4 pf, 4 pfs, 4th foul, 5 fouls, 5 pf, 5
pfs, 5th foul, 6th foul, fifth foul, five fouls, foul out, foul trouble, fouled out, fouling out, fouls out,
four fouls, fourth foul, in foul trouble, pick up, picked up, picking up, picks up, second foul, six fouls,
sixth foul, third foul, three fouls, two fouls
WEB_OPINION
a joke, affection, aka, alive, amaze, amazed, amazes, amazing, asap, ashamed, awful, bad, bad
news, bad sign, bad signs, beautiful, beauty, best, best sign, best signs, better, biggest, brilliant,
btw, bum, bummer, bummers, bums, by the way, c'mon, came alive, classic, come alive, come one,
coming alive, cool, crack, crap, crappy, crush, crushed, crushes, crushing, deserve, deserved,
deserves, deserving, dick, dogged, dogging, dogging it, don't know, don't think, drama, dramatic,
dude, dumb, dumber, effort, excellent, excited, excitement, excites, exciting, excuse, excused,
excuses, excusing, expect, expected, fact, fair, fairly, fml, fuck, fucked, fucked up, fucking, fucking
up, fucks, fun, funny, fwiw, fyi, genius, geniuses, god, gonna, good, good news, good sign, good
signs, gosh, gotta, gotta like, great, ha ha, haha, happy, hard, hate, hater, haters, hatin, hating,
heart, heart break, heart breaker, heartbreak, heartbreaker, heck, hell, high note, highest,
hilarious, hilariously, holy cow, holy shit, homo, horrendous, horrible, horrid, huge, i can't, i expect,
i expected, i guess, i like, i liked, i miss, i think, i thought, idiot, idiots, imo, in da house, in fact, in
the house, insult, insulting, insults, interesting, issue, issues, j/k, jk, joke, joked, jokes, joking, just
shoot me, kidding, kinda, kinda like, knew, know, knowing, knows, like, liked, likes, liking, literal,
literally, lively, lmac), lmfao, lol, lols, lolz, love, loved, loves, loving, lowest, luck, luckily, lucky,
ludicrous, maybe, moron, morons, must, must have, my god, my gosh, naturally, nice, nicely, nicer,
nicest, no excuse, no excuses, not good, not happy, not sure, not thrilled, nothing like, obv,
obvious, obviously, of course, oh crap, oh my, oh my god, omg, on crack, on drugs, passion, poor,
poorly, pretty, quality, quit, quits, quitter, quitters, quitting, really, really good, ridiculous,
ridiculously, right?, serious, seriously, shame, shamed, shameful, shamefully, shit, shitty, shocking
shoot me, shut up, shuts up, sick, smh, smoking, soft, softer, softie, spark, sparked, sparking,
sparks, stfu, stupid, sucks, sure, surprise, surprised, surprises, surprising, swag, swagger, talking
about, terrible, terribly, the best, the heck, the hell, the spark, the worst, think, thinks, thought,
thoughts, thrilled, thriller, thrilling, tough, tougher, tremendous, tremendously, ugliest, ugly,
unacceptable, unfair, unfairly, unhappy, unsure, very good, weird, what the, whoa, whoah, wierd,
wonder, wondered, wondering, worried, worries, worry, worrying, worse, worse than, worst, worst
sign, worst signs, worst time, wow, wrong, wtf, yikes, you serious

It is useful to organize terms by category, since there are sufficient samples of messages with scores for a category, to be useful for training. When trying to determine how relevant is a message with a 0.8 score for a player and a 1.0 score for category “injury,” that is something that a machine learning system can build a good prediction for. It would not be possible to build such a system that considered the occurrence of thousands of individual terms. Individually, each term occurs too rarely to be relevant, expect for a select few. But by adding terms for a small number of distinct categories, the system can extract meaning from tweets. If the system encounters a tweet like “LeBron is sitting with an ice pack on his knee,” it will not be able to determine the exact meaning of that message, but it can determine that the message is about player LeBron and describes an injury.

The following output is initiated by a text that reads “Ok, so apparently it's a full body bruise (wrist/back/hip) for @Goran_Dragic who won't return. #Suns down 57-46 w/10:17 to go in 3rd.”:

```
Ok, so apparently it's a full body bruise (wrist/back/hip) for
@Coran_Dragic who won't return. #Suns down 57-46 w/ 10:17 to go in
3rd. (284138835221307392)
    sec_since: 9
    scores: [[46, 57], [10, 17]]
    acc: Azbloom list: /live_bball/suns-bball
Game Status: Q3-9:44 (54.0%)
    46-59 (−13) 21:44 pace: 98.6
    home_WP: 125 excitement: 45
ok so apparently it s a full body bruise wrist / back / hip for
@ goran_dragic who won t return # suns down 57 46 w / 10:17 to go in
3rd
After consolidation, found 4 matched entities:
    PhraseCategory(time_narrative)[153] 1.0 to go ; in 3rd
    TeamName(1000)[82] 0.7: goran_dragic : suns
    PlayerName(1003)[82] 1.0: goran_dragic
    PhraseCategory(injury)[42] 0.7: bruise ; won t return
    training model value: 0.56
injury tweet for player Goran Dragic
```

From this message, the system matches the terms “to go” and “in 3rd” for the term category “time_narrative.” The system matches “Suns” and player name “Goran_Dragic” to indicate the entities present, and finds the terms “bruise” and “won't return” to match the term category “injury.” It also notes all of the players, teams, and categories that are not matched. Thus the system is able to conclude that this is an injury-related tweet about Suns' player Goran Dragic. The source of this tweet is Suns reporter “Azbloom;” it was written 9 seconds before being processed by the algorithm, and the system also matches the score of the game 57-46 within the tweet, which is only two points off from the score according to the system (59-46). Thus the system has further proof that the tweet is relevant to the game, it's coming from a good source, and that it is current to the live game.

The following output is initiated by a text from Lakers reporter ArashMarkazi that reads “Whenever Jordan Hill has a game like this I′m amazed he's had two DNP-CD's under D'Antoni.”:

```
Whenever Jordan Hill has a game like this I'm amazed he's had two DNP-
CD's under D'Antoni. (284149005758390272)
    sec_since: 172
    acc: ArashMarkazi  list: /ivan_bezdomny/takers-bball
    result: 0
Game Status: Q4-5:48 (87.0%)
    113-102 (11) 5:48 pace: 116.3
    home_WP: 951 excitement: 56
whenever jordan hill has a game like this i m amazed he s had two dnp
cd s under d antoni
After consolidation, found 6 matched entities:
    PhraseCategory(general_event)[32] 0.2: game
    PlayerName(3008)[10] 1.0: jordan hill
    PhraseCategory(web_opinion)[38] 0.4: like ; amazed
    PhraseCategory(emotion)[0] 0.2: whenever
    TeamName(3000)[10] 0.3: jordan hill : d antoni
    CoachName(3000)[100] 0.5: d antoni
    training model value: 0.49
Found minimal proof of specific entity to continue with Team account
tweet
Found qualifying PLAYER entity_id match PlayerName(3008)[10] 1.0:
jordan hill
Found qualifying COACH entity_id match CoachName(3000)[100] 0.5:
d antoni
Found 2 possible entity matches for the story:
[[1.0049007999999999, 3008, ‘Jordan Hill’], [0.50400500000000004,
3000, “Mike D'Antoni”]]
Story primarily about entity_id: 3008
priority = 275 + 372 (model 0.49) + 162 (sec_since 56) = 809
```

The system's algorithm finds text matches for player Jordan Hill, Lakers coach Mike D'Antoni, and several term categories: “game” matches the “general_event” category, “like” and “amazed’ match the “web_opinion” category, and “whenever” matches the “emotion category. The system also notes the matches that are not present. There are no other players, and there is no injury information, details about the game, or injury information. Thus the system can conclude that the message is primarily about player Jordan Hill, and that the writer is giving an opinion on Jordan Hill, since he uses emotional, opinionated language. The system's algorithm cannot determine what the opinion is, but it is known that a trusted Lakers report is giving an opinion on one of their players, and there is a good likelihood that the message contains no other major piece of information, like an injury or game update.

Several kinds of data including game status data 408 are merged with each tweet at step 409 to create full data for tweets 410. There is the author, the author's category (e.g., team writer or national blogger), the recency of the post, any game score within the post, and the closeness of that score to the real score. The system also defines 0.0-1.0 matches for each possible game entity in the post, including players, coaches, and the teams and it defines a 0.0-1.0 match for each of the term categories, which include sport-specific categories such as “time narrative,” “score,” “general event,” “specific event,” “foul event,” player description,” and “injury.” The system also tracks meta-categories more generally relevant to social media, such as “link,” “retweet,” “emotion,” “web_opinion,” and “cheering.” From this data, the system also derives values for higher-level categories such as the number of players mentioned, yes/no whether a team is mentioned and yes/no whether there is a game score within six points of the real score (from game status data 408) in the tweet text. These features are used in a machine learning system trained with real tweets, to recognize relevant game tweets among future candidates.

Three things are important in applying a machine learning (ML) model 418 to understand in-game tweets: likely relevance for (e.g., a score from 0% to 100% representing how likely a tweet is worth including in a live game timeline), topic, and primary entity (player, team, or coach) of the tweet. The system cannot know for sure that the author of the tweet is writing, but it can estimate what type of update is being given. Is the author describing an injury? Is he giving a detailed description of a play? Is he giving an update about a player? Is he cheering or offering an opinion? Machine learning is used to answer these questions, meaning that humans label real game tweets with the correct values to such questions. Using labeled data and the organized data for each tweet as described above, a model is then trained to answer these questions for tweets collected during future games.

In collecting a set of human-labelled tweets for relevance 412 and categories 413 for use in machine learning training steps 414 and 415, a web-based system can be used to show people tweets during live games, for their categorizing and identification as relevant or not. For example, as shown in FIG. 7, humans were asked to label live tweets during a game between the Golden State Warriors and the Oklahoma City Thunder. The people asked to label tweets are looking for tweets that they deem to be of enough relevance and a high enough quality to be included in a live timeline describing the game. Their aggregated opinion of relevance and quality is then measured.

Thousands of labeled tweets, positive examples and counter-examples are provided for what is a relevant tweet in a variety of real game situations. The data about each tweet (extracted as described above), as well as data about the state of the game in each instance, is used to create a machine-learning estimate of how likely a given tweet would have been chosen by the selected group of humans, given the text in that tweet, the author, and the game situation in question. For example, from the screen shot above, “Meanwhile, Monta Ellis hits a jumper at the buzzer to give the W's a 29-25 lead after one” was deemed a good tweet, and thus labeled 1.0 by the human. “Beautiful give and go by Serge Ibaka and KD” was also given a 1.0 label. But the tweet “anyone over the age of 13 with a Mohawk, frohawk, or anything similar is an idiot” was not selected, and thus given training label 0.0.

The human labelling should focus on quality, not just relevance. The system can confidently guess that if the human had seen a tweet like “I like my dog Durant #NBA http://spam.com,” then this tweet would not have been selected, even though it mentions a relevant player name and league name. The humans looking at tweets should be asked to give reasons for why they choose some tweets and not others, as well as whether a tweet meets their internal definition of relevance and quality as it pertains to a given game. While humans provide data that is either 1.0 or 0.0 for each tweet, the machine learning model for tweet relevance 416 will output a number between 0.0 and 1.0 as an estimate of confidence. For example, it might label the following labels for tweets in the game labeled above: “Monta's buzzer-beating jumper puts GSW up 29-25 at the end of the 1st quarter” would get label 0.5; “Thunder doesn't look into it offensively or defensively” estimated relevance label 0.6; “Thunder and lightning!” estimated label 0.1.

Given the trained data, one of ordinary skill can train a machine learning system to estimate relevance for future tweets, using any of a number of machine learning software packages and algorithms. The system inputs the data to the machine learning system WEKA, and finds a linear model that considers the data about each tweet, and outputs a value from 0.0 to 1.0. Now the system has a value from 0.0 to 1.0 from the machine learning system, with which to estimate the relevance of each tweet. The system will use this to choose tweets for iterative game coverage timelines, such as shown in WEKA output from a sample training using a linear formula in the following table:

| | |
|---|---|
| === Run information === | Test mode: evaluate on training data |
| Scheme: | === Classifier model (full training set) === |
| weka.classifiers.functions.LinearRegression -S | Linear Regression Model |
| 0 -R 1.0E−8 | train_result = |
| Relation: combined-retweet-v2- | −0.0003 * text_len + |
| weka.filters.unsupervised.attribute.Remove- | 0.0053 * text_words + |
| R3-5- | 0.0225 * down_to_wire=FALSE + |
| weka.filters.unsupervised.attribute.Remove- | 0.0304 * game_close=FALSE + |
| R8-9- | 0.0584 * team_match_score + |
| weka.filters.unsupervised.attribute.Remove- | 0.0249 * num_teams_match + |
| R8- | −0.0914 * coach_match_score + |
| weka.filters.unsupervised.attribute.Remove- | 0.2073 * num_coach_match + |
| R13,19-20 | 0.0986 * player_match_score + |
| Instances: 14329 | −0.034 * multiple_teams + |
| Attributes: 29 | −0.0571 * two_players + |
| text_len | 0.0457 * three_players + |
| text_words | −0.2095 * four_players + |
| frac_spent | −0.1787 * five_players + |
| time_early | 0.2532 * cheering + |
| time_late | 0.3405 * emotion + |
| down_to_wire | 0.1914 * general_event + |
| game_close | 0.2989 * injury + |
| team_match_score | −0.3548 * links + |
| num_teams_match | 0.2804 * player_desc + |
| coach_match_score | −0.5736 * retweet + |
| num_coach_match | −0.3127 * score + |
| player_match_score | 0.1639 * specific_event + |
| multiple_teams | 0.0973 * time_narrative + |
| two_players | 0.0947 * web_opinion + |
| three_players | −0.0425 |
| four_players | Time taken to build model: 0.52 seconds |
| five_players | === Evaluation on training set === |
| cheering | === Summary === |
| emotion | Correlation coefficient 0.3532 |
| general_event | Mean absolute error 0.268 |
| injury | Root mean squared error 0.3605 |
| links | Relative absolute error 90.219 % |
| player_desc | Root relative squared error 93.5531 % |
| retweet | Total Number of Instances 14329 |
| score | |
| specific_event | |
| time_narrative | |
| web_opinion | |
| train_result | |

The above model uses several features. There are “text_len” and “text_words,” which give the message length. There are “frac_spent,” “time_early,” “time_late,” “down_to_wire,” and “game_close,” which are features related to the state of the game. The values “team_match_score,” “num_teams_match,” “coach_match_score,” “num_coach_match,” “player_match_score,” “multiple_teams,” “two_players,” “three_players,” “four_players,” and “five_players” are features about the number of entities matched, the type of entities (players, coaches and teams). Lastly, “cheering,” “emotion,” “general_event,” “injury,” “links,” “player_desc,” “retweet,” “score,” “specific_event,” “time_narrative,” and “web_opinion” are the features giving a 0.0 to 1.0 value for the text match within each text category that are pertinent. Using these values, a model is needed to estimate “match result,” which is the average label of all the humans that saw this tweet and classified it as relevant or not. A person of ordinary skill in the art can produce a machine learning system with the data from each tweet and the human labels as described above, for example using linear models (discussed above) and piecewise linear models like M5 Prime, constructed for example using a SVM (Support Vector Machine) approach.

Similarly to training for relevance, humans are asked to label tweets for relevant tweet categories. This labeling is on a smaller sample, since only tweets that were already selected as relevant to the game are considered. For each tweet, people are asked to choose the best category, such as: giving an injury update; describing a player's performance or game status; describing fouls or officiating; describing a play on the court; giving an opinion about a team, player or coach; cheering for a team or player; or relevant but none of the above. As with relevance training, a machine learning model for tweet categories 417 can be trained to estimate the likelihood that a tweet belongs to either of these categories, or a multi-category classification system can be trained.

Finding the “most relevant entity” for each tweet does not require any machine learning training. Instead, the system simply looks for the player, team or coach with the highest match score, provided that one of these scores is above 0.5 out of 1.0. The system is arranged such that a team mention only results in a 0.5 score for the team entity object, thus a full player name mention and a team name in the tweet will result in the player being the “most relevant entity.” However the player matches are also added, at a discount, to the team score match. Thus, if four players on a team are mentioned, then the team becomes the most relevant entity, rather than any of the individual players. If two players have the same match score, the player mentioned first in the tweet's text is chosen. This system works well in the vast majority of cases, so there may be no need to train a more complex entity-choosing system, although this could be done in a similar method to the way relevance scores and tweet labels are applied.

Once social media messages (tweets) are processed, they make their way into the iteratively written live game timelines as tweet stories 419, in a similar manner that generated messages are chosen for timelines. For each tweet, the system maps the relevance score (0.0 to 1.0 from the machine learning algorithm) to tweet story scores, on the same scale as the story scores for generated stories. For example, a relevance score of 0.2 maps to a tweet story score of 400.0, while a relevance score of 0.8 maps to a tweet story score of 1000.0. The system does not consider tweets with relevance scores below 0.2. The most likely story category (from machine learning training) becomes the tweet story type. For example, from the tweet shown above, “Ok, so apparently it's a full body bruise (wrist/back/hip) for @Goran_Dragic who won't return. #Suns down 57-46 w/10:17 to go in 3rd” gets the story type TweetInjury, since it is an injury story formed from a tweet. The Entity for this story is of course Suns player Goran Dragic. With a few small differences, the system thus can process tweets as it would generate stories, including merging them at step 420. It has a story score, a story type, and a primary entity.

Just as with generated stories, the system considers tweet story candidates 421 for addition to the iteratively written timelines. First the system generates all current tweet stories. Then it rescores these stories by applying story demotions, based on similarity to recently written stories, topics and entities. The system also demotes stories if the tweets from which they are derived are not very recent, or if these stories mention game scores that are too dissimilar to the current game score. Then the system computes the minimum cutoff to write the next tweet story for each timeline, and writes such stories if any qualify. Once the system can rescore tweet stories based on previously written stories and adjust the minimum story output cutoff for tweet stories in order to reflect an expected output rate, it has everything needed to add tweet stories to various timelines. This proceeds in the same way that generated stories are added to game timelines. In addition to the recency demotion for tweet stories, the system also demotes stories if the timeline already includes recent stories from that same author. All else equal, it is preferred that the timelines use as many sources as possible.

In order to write some timelines toward one team or the other, the system may also systematically promote or demote qualifying tweets based on the category to which their writer belongs. The system can create one timeline that prefers authors covering the home team, and another that prefers authors covering the away team. By the same token, the system can have a timeline that prefers professional writers over bloggers, or national writers over local writers. Thus, small changes can be made in scores that will dramatically increase which types of voices get coverage in timelines, without excluding the other authors' tweets, especially if those tweets are very relevant, or if there is a dearth of relevant tweets from preferred sources. This preference for sources can be taken further, with a system tailored to individual users. Users can choose which sources of in-game tweets they prefer, and add their own sources (such as their friends' social media messages), while still getting relevant messages from all of the sources for their game, blended into one timeline.

Referring to FIG. 5, the system preferably blends both generated stories 508 and generated tweet stories 507 into a single live commentary timeline, iteratively appending to timelines at step 516 current generated stories and tweet stories. The system preferably maintains separate minimum story cutoffs for generated and tweet stories to ensure that both kinds of stories are included, outputting the top generated story at step 514 and the top tweet story at step 515. The cutoffs for both types are affected by recency and frequency so that, for example, tweet stories about a given entity will be demoted (rescored) at step 511 if there was a timeline tweet story 513 about that entity within a given time. As shown by the connection between steps 512 and 511 and the connection between steps 513 and 510, such rescoring can be taken further by defining some generated story types and tweet story types as weak matches for each other. For example, generated story types TopOffensivePlayer and BadOffensivePlayer are both weak matches for the tweet story type TweetPlayerDescription. Thus if a story is generated about LeBron and a tweet about LeBron that covers the same general topic, whichever story is written first will demote the writing of the other story.

As noted, the system produces a working live game commentary from two sources of data: structured data about the game from official play-by-play information 501, and unstructured text social media messages (new tweets 502, which are parsed and classified at step 504 based, inter alia, on machine learning models for tweet classification 506), which may or may not be about the game in question. These data are turned into individual stories, and the stories (of both the structured and unstructured type) are chosen for incorporation into a live, iteratively constructed timeline. This system can then be improved by allowing structured and unstructured elements to interact explicitly, in some cases.

Since much is known about live game data, preference can be given to tweets about players doing something significant in the game, and to tweets that mention the types of information not covered in the generated stories. For example, if it is known that Lakers player Pau Gasol is currently playing, and contributing to a lot of plays, the system would give preference to tweets describing his performance, even if those tweets have only a weak match for his name (in player, team, and coach nicknames 505). On the other hand, if the system knows that Pau was on the bench or just not contributing, it would be less likely to promote tweets with his name, and might even suppose that some tweets with “Gasol” are actually about his brother Marc Gasol of the Grizzlies. In other words, the system's algorithm looks for names of players who are in the game. This can be extended by giving preference to tweets about players who are contributing at the moment, meaning the system does not incorrectly take good social media messages about other games as pertaining to a player in the present game, who had a play an hour ago. (This is more important in certain other embodiments, such as one directed to football games, in which many more players participate in a given game, making it more important to distinguish between those who contributed, and contributed lately, as opposed to those simply on the roster).

The system can also give preference, among several tweets about an entity, to those containing information that generated stories are missing. For example, if Kobe Bryant's stats are known, a message giving his statistical breakdown is not as useful as one giving a Kobe Bryant injury update or one giving an opinion on his performance. As described in the previous section, this is effected by making some generated story types weak matches for some tweet story types. Thus if the system wrote about Kobe Bryant's foul trouble in a generated story (PlayerFoulTrouble), then it will subsequently demote a tweet story about Kobe that is primarily about fouls and officiating (TweetFoulEvent). This makes for a more interesting timeline, with fewer redundant messages.

Injuries are not reported in play-by-play data, and not knowing that a player is injured leads to inaccurate stories. For example, it would be misleading to write that “Goran Dragic has only played 10 minutes, although he is not in foul trouble,” when he is injured. Thus, it would be preferable to remove “only played [number] minutes” stories for a player known to be injured. The system therefore can treat tweet game stories of type TweetInjury as structured data indicating that the given player is injured, and feed it into the player, team, and game status data 503 that is used along with league norms 509 to generate stories. Given enough evidence (e.g., three or more social media injury stories primarily about that player), the system can generate stories reporting that player as injured. For the preceding example, the system would write “Before going down with injury, Goran Dragic contributed little with 4 pts (2-6 FG), 2 assists and a turnover in 20 minutes:

Suns

Before going down with injury, Goran Dragic contributed little
with 4 pts (2-6 FG), 2 assists and a turnover in 20 min.

| | |
|---|---|
| Q4-0:00 | NYK 99-97 PHX |

Since the system is tracking the tweets used as evidence of said injury, it also can credit the source of its information, and quote the most commonly used injury term from the various sources, “According to @HollingerNBA, Goran Dragic won't return, with injury.” The system also preferably can stop generating an inaccurate story and replace it with a useful story, based on data extracted from social media updates.

Game state tracking and social media message processing can also be used to find live in-game video clips relevant to the game, by looking for video links added by social media, and/or, e.g., directly tracking relevant channels on YouTube. For each video that might warrant inclusion, the system applies the same relevance scoring used to find good live tweets, recognizing that most good video links are added by national but not team-specific sources on social media. The system may also look for rich media about a live game by explicitly offering generated game stories as searches. For example, if an important play occurred consisting of a LeBron James dunk, the system could explicitly search for recently posted videos with that title. Such searches can be offered in real time since the system closely follows the state of the game and converts the most important current game angles into well-formed English phrases.

Referring to FIG. 6, many live timelines 611 for different audiences (requirements) and for different timeline needs 601 can be generated simultaneously through story generators 608 as detailed above, tweet story generation and scoring 609 as described above, with outputs modified according to desired output rate 602, story length restrictions 603, media type restrictions 604, preference for sources 605, and personally-added tweet sources 610.

Beyond writing streaming text updates to many different kinds of readers, specially-defined live iterative timelines can also be used to create mobile notification for live games, and to push live voice alerts to users' phones, for example with media type restrictions 604 such as to users who are driving a car while their favorite team is playing. In both cases, social media messages cannot be used directly, since it is not known exactly what these messages are saying, and because some of the words used cannot be pronounced. Conversely, for generated text, what the message is saying is exactly known, so versions of such messages can be tailored to use as very short and very direct mobile notifications, and versions of such messages can be tailored that make for good text-to-voice pronunciation. They can then be used as a pronunciation guide for team and player names, some of which would otherwise be inadvertently mangled by the speech rendering.

Even though social media updates cannot be used to create push notifications for voice or text, it can help verify whether it is worth interrupting the user with an update. In the case of timelines that allow 20 or 100 messages per game (per desired story output rate 602), this is not that important, but for embodiments for which a game update is only desired when something truly interesting occurs, tracking social media stories and using them to promote related generated stories can help keep a user informed about the most important events happening right now in sports. These stories would be tailored to give preference to his favorite teams or based on preference for sources 605, without missing historical achievements or exciting games that may be happening elsewhere.

One skilled in the art will appreciate that other variations, modifications, and applications are also within the scope of the present invention. Thus, the foregoing detailed description is not intended to limit the invention in any way, which is limited only by the following claims and their legal equivalents.

What is claimed is:

1. A system for providing text coverage of a live event, comprising:
a. one or more computing devices configured to receive information from one or more structured data sources and from one or more unstructured data sources, and to output information derived therefrom in a periodically updated timeline;
b. a game data processing system comprising a system for deriving data and a story generation system;
c. a social media processing system; and
d. a data source mixing system.

2. The system of claim 1, wherein said system for deriving data is adapted to receive structured data.

3. The system of claim 2, wherein said structured data includes game status data.

4. The system of claim 3, wherein said structured data further includes player data and team data.

5. The system of claim 1, wherein said story generation system comprises a plurality of story generators of different categories.

6. The system of claim 5, wherein said different categories of story generators include player stories, team stories, and game status stories.

7. The system of claim 6, wherein said story generation system is adapted to select from candidate stories produced by said plurality of story generators and merge them.

8. The system of claim 1, wherein said social media processing system is adapted to receive unstructured data and to parse text therefrom based on rules.

9. The system of claim 1, wherein said social media processing system is further adapted to receive data from said game data processing system.

10. The system of claim 1, wherein said social media processing system is adapted to generate and merge social media-derived stories.

11. The system of claim 1, wherein said data source mixing system is adapted to iteratively control output from said game data processing system and output from said social media processing system, and to selectively append said outputs to said periodically updated timeline.
